(19) United States
(12) Patent Application Publication
(10) Pub. No.: US 2005/0036483 A1
(43) Pub. Date: Feb. 17, 2005

(54) Method and system for managing programs for web service system

(76) Inventors: Minoru Tomisaka, Yokohama (JP); Isamu Adachi, Yokohama (JP); Naotaka Kumagawa, Yokohama (JP)

Correspondence Address: Mattingly, Stanger & Malur, P.C.;Suite 370, 1800 Diagonal Road, Alexandria, VA, 22314, US

(21) Appl. No.: 10/892,182

(22) Filed: Jul. 16, 2004

(30) Foreign Application Priority Data
Aug. 11, 2003 (JP) 2003-207003

(51) Int. Cl. H04L 1/00

(52) U.S. Cl. 370/352; 709/203; 370/254; 709/223

(57) ABSTRACT

A Web service status management service is provided independently of processing nodes related to a Web service case. Information for uniquely identifying the status management service is added to messages transmitted and received between the processing nodes. Communication between each of the processing nodes and the status management service makes it possible for the status management service to record the status condition of a specific Web service case. Then, according to the recorded status condition, a notification for cancellation of the case can be directly transmitted to the processing nodes related to the specific Web service case.

### INCORPORATION BY REFERENCE

The present application claims priority from Japanese application JP2003-207003 filed on Aug. 11, 2003, the content of which is hereby incorporated by reference into this application.

### BACKGROUND OF THE INVENTION

The present invention relates to a service processing technology for managing a plurality of processing nodes that provide services.

As multistage Web services using coordination among a plurality of sub Web services provided by the processing nodes distributed over a plurality of servers, there is a provided a technology as described in David A. Cbappell et al. “Java Web Services”, O'Reilly & Associates, Inc., 2002. 3, page 6. When the need for canceling a Web service case arises due to a request from a client, occurrence of an error in a processing node, or the like, and when the cancellation event of the Web service case is notified to each of the processing nodes, the sequential notification of the cancellation event through a transmission path of messages related to the Web service case becomes necessary. Such notification becomes necessary because of the characteristic of the Web service that the client and each of the processing nodes cannot know the entire contents of sub Web services related to the Web service case.

### SUMMARY OF THE INVENTION

In the Web service, a flow is not defined in advance, each of the processing nodes can determine its subsequent node, and the flow control of a centralized management type by business flow servers is not performed. Thus, in an approach in a conventional business flow system, a status condition (progress condition) cannot be tracked, and the node to which cancellation of a service case should be notified cannot be known.

An object of the present invention is therefore to manage a plurality of processing nodes that execute a Web service when the Web service is executed by the processing nodes.

Other object of the present invention is to notify the processing nodes that execute a Web service of an error or a failure when the failure or the error has occurred in each Web service case.

In order to achieve the above-mentioned objects, a Web service status management service that can be present independently of processing nodes related to a Web service case is provided. Information for uniquely identifying the status management service is added to messages transmitted and received between the processing nodes. Communication between each of the processing nodes and the status management service makes it possible for the status management service to record the status condition of a specific Web service case. Then, a unit for enabling direct transmission of a cancellation notification of the case to the processing nodes related to the specific Web service case in accordance with the recorded status condition is provided, thereby achieving the above-mentioned objects.

The status management service is associated with each of the processing nodes by a specific Web service case and information included in messages related to the specific Web service case, transmitted and received between the processing nodes. By this information, the status management service can be uniquely identified. Accordingly, depending on each Web service case, the related processing nodes and the related status management service may differ.

According to the present invention, when executing a service by a plurality of processing nodes, management of the processing nodes that execute the service becomes possible.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing an entire configuration of the present invention;

FIG. 2 is an explanatory drawing showing an example of execution of cancellation;

FIG. 3 is an explanatory drawing showing a processing flow of a status management service;

FIG. 4 is an explanatory drawing showing a processing flow of each processing node;

FIG. 5 is an explanatory drawing showing an example of a case status table;

FIG. 6 is an explanatory drawing showing an example of a message transmitted and received between processing nodes;

FIG. 7 is an explanatory drawing showing an example of the content of a notification of transmission destination information;

FIG. 8 is an explanatory drawing showing an example of the content of a notification of cancellation; and

FIG. 9 is an explanatory drawing showing an example of a plurality of flows of service processing messages and notifications of transmission destination information when a plurality of status management services is present.

### DESCRIPTION OF THE EMBODIMENTS

1. First Embodiment

An embodiment of the present invention will be described below.

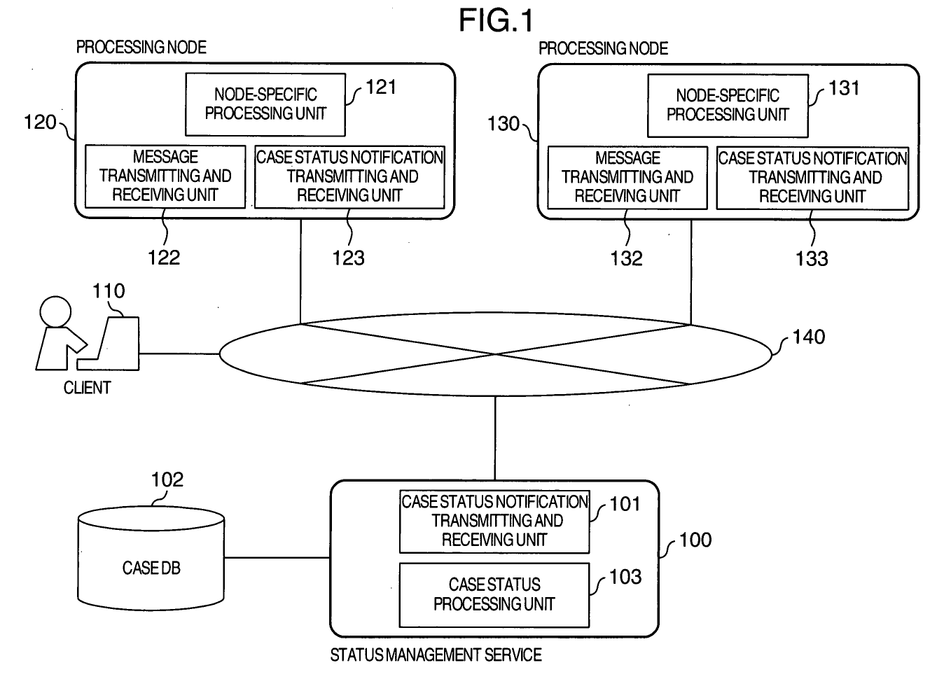

FIG. 1 is a diagram showing an entire configuration, for explaining the present invention. Referring to FIG. 1, a status management service 100 functions to manage status conditions of the case of a Web service constituted from a plurality of sub Web services provided by a plurality of processing nodes. A client 110 is a Web service terminal, and each of processing nodes 120 and 130 provide a sub Web service constituting the Web service. The client 110, the processing nodes for the Web service, and the status management service (or a management node) are connected over a network 140.

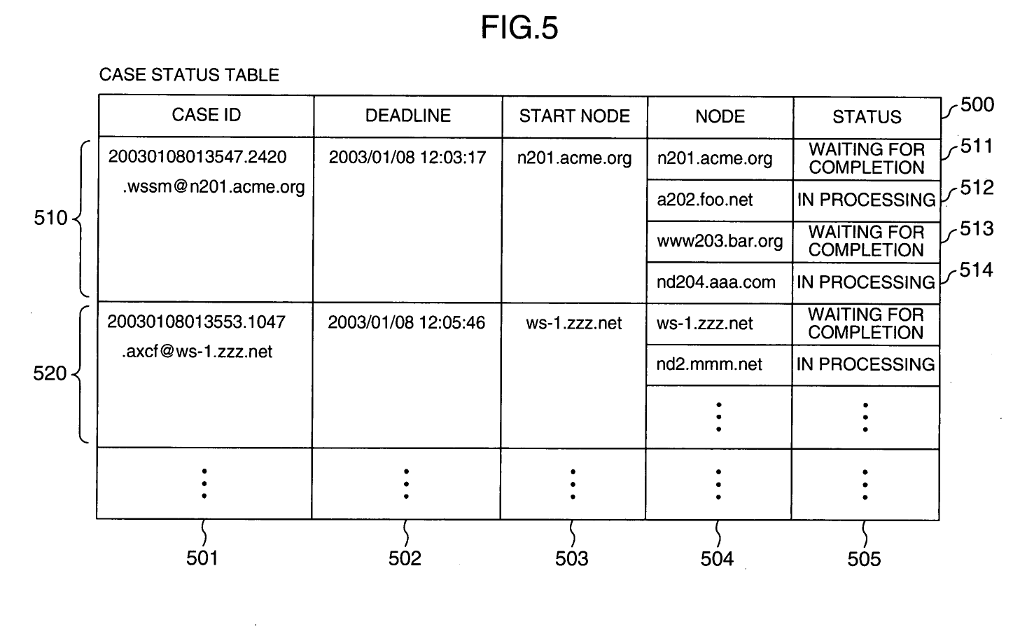

The status management service 100 includes a case status notification receiving and transmitting unit 101, a case database (DB) 102, and a case status processing unit 103. The case status notification receiving and transmitting unit 101 receives and transmits status information of the Web service case and a notification of cancellation of the case from each of the processing nodes. The case database 102 holds case status information. The case status processing unit 103 updates the case DB 102 in accordance with the information received by the case status notification transmitting receiving unit 101. The case DB 102 stores contents as shown in a case status table 500 in FIG. 5, for example, which will be described hereinafter.

The processing node 120 includes a node-specific processing unit 121, a message transmitting and receiving unit 122, and a case status notification transmitting and receiving unit 123. The processing node 130 includes a node-specific processing unit 131, a message transmitting and receiving unit 132, and a case status notification transmitting and receiving unit 133. Each of the node-specific processing units 121 and 131 executes the function provided by the associated sub Web service. Each of the message transmitting and receiving units 122 and 132 exchanges a message with the client 110 and with other node. Each of the case status notification transmitting and receiving units 123 and 133 exchanges status information on a Web service case and the notification of cancellation of the case with the status management service 100. The processing node in this embodiment may be a computer, logical computer, or a logical server, which can run a program that processes a Web service, or the program or an object for processing the Web service.

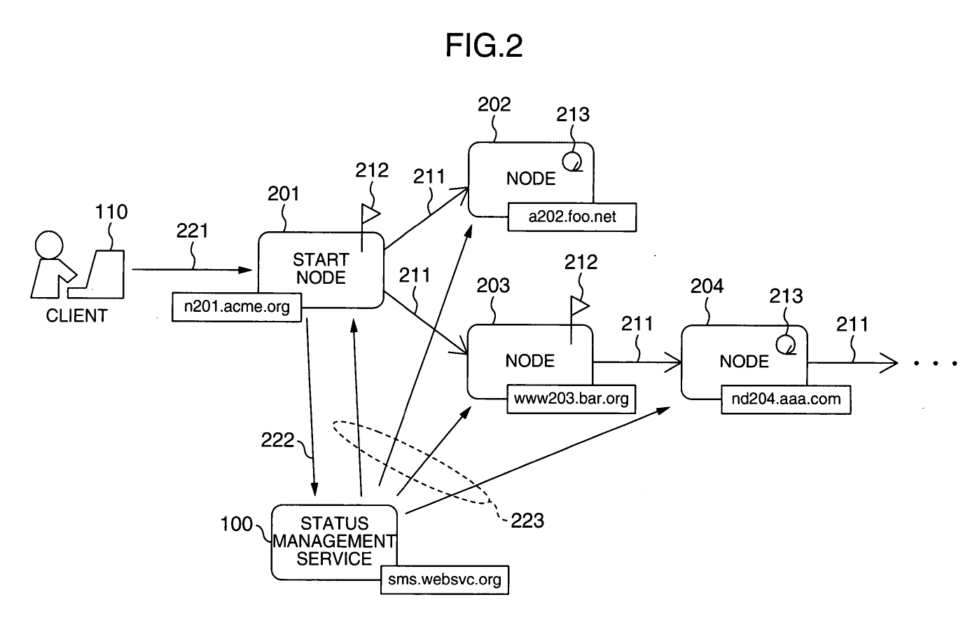

FIG. 2 shows a flow of messages for executing cancellation of the case of a Web service according to a message requesting cancellation of the case from the client. Processing of the status management service may be performed by a start node. This makes it possible for the start node to perform status management of service processing by respective nodes and cancellation management.

Referring to FIG. 2, the Web service is constituted from a plurality of sub Web services. By transmitting a message requesting execution of the Web service to a start node 201 by a client 110, the Web service is executed by the start node 201 and other processing nodes 202, 203, and 204. Incidentally, the client 110 may also serve as the start node 201.

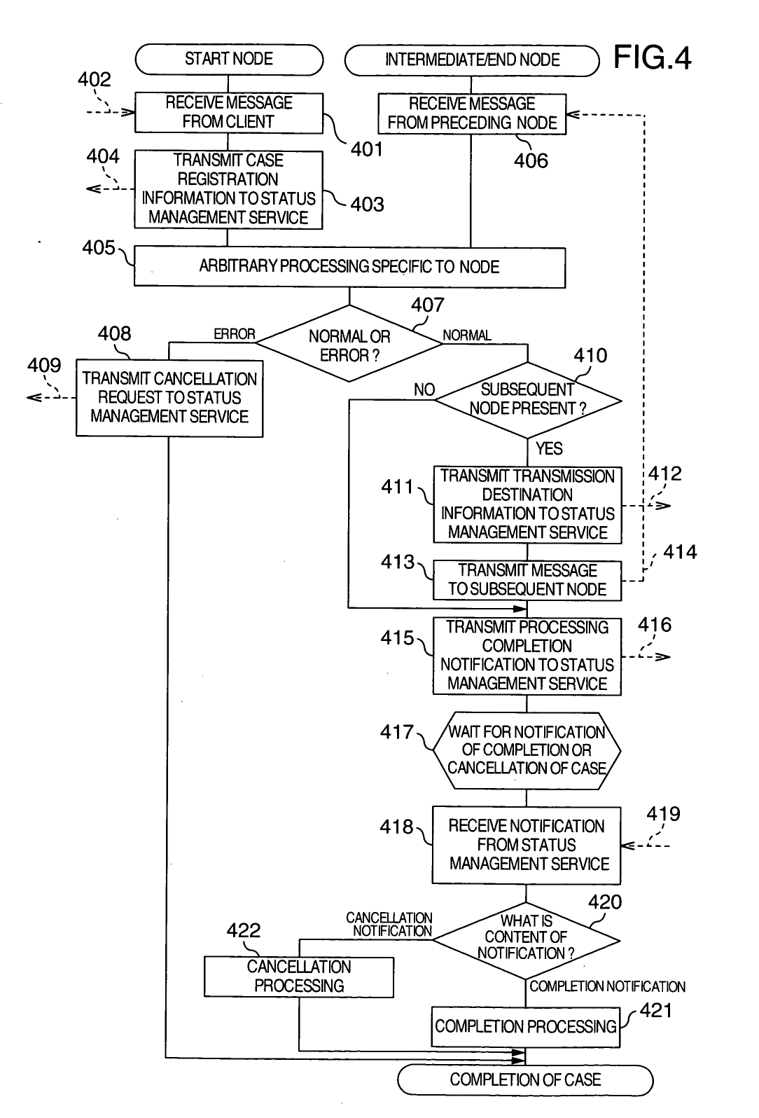

Each of arrows 211 indicates a flow of a message transmitted and received between the nodes for execution of the Web service, and corresponds to a message 414 in FIG. 4, which will be described hereinafter. Each of symbols 212 indicates a state of finishing node-specific processing and waiting for the reception of a notification of the case completion or the case cancellation. Each of symbols 213 indicates a state of performing the node-specific processing.

A message 221 is the message requesting cancellation of the Web service case being executed. The start node 201 that has received the message 221 transmits to the status management service 100 a notification 222 to the effect that a cancellation request has been made.

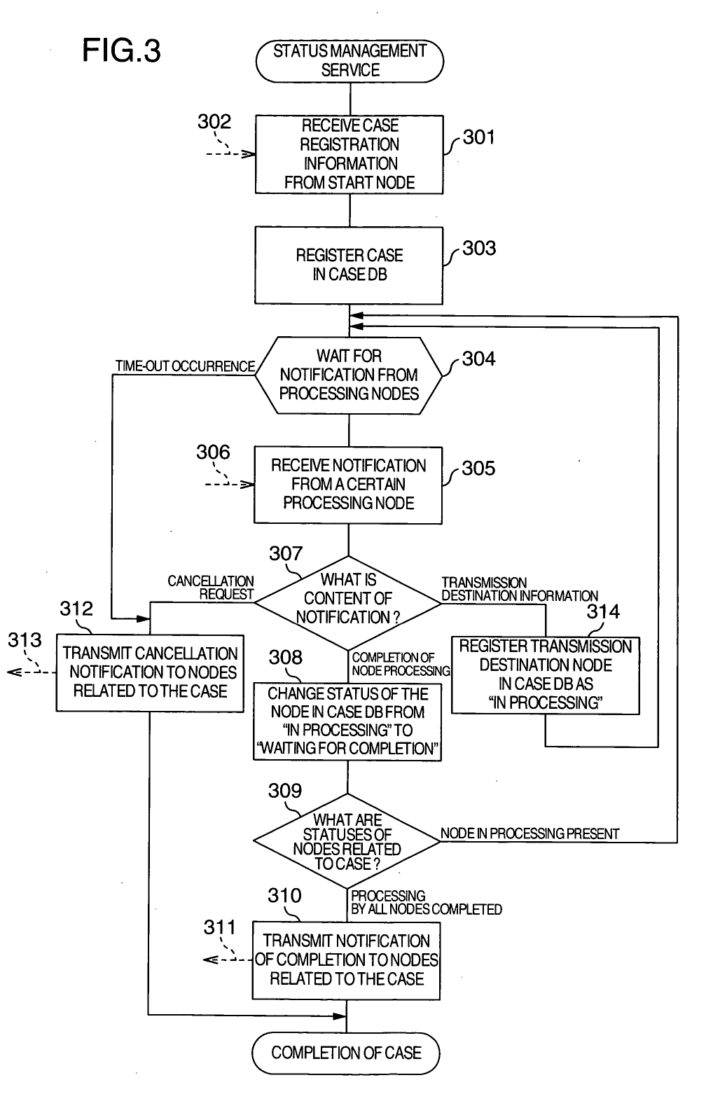

The status management service 100 that has received the notification 222 transmits the notification of cancellation of the Web service case to the nodes 201, 202, 203, and 204 involved in the Web service case, in response to a notification 404, 412, or 416 in FIG. 4 or a notification 302 or 306 in FIG. 3, which will be described hereinafter, in accordance with information on the node states indicated by the symbols 212 and 213 and information in the nodes 201, 202, 203, and 204 already sent along the execution of the Web service.

FIG. 3 shows a processing flow of the status management service 100. First, at step 301, the status management service 100 receives the case registration information 302 from the start node 201 at the start of a Web service case. The case registration information 302 corresponds to the case registration information 404 in FIG. 4, which will be described hereinafter.

Next, at step 303, the status management service 100 registers the case in the case DB. By registration of the case, a record 510 in FIG. 5, which will be described hereinafter, is created, and information is recorded in a case ID field 501, a deadline (expiration) field 502, and a start node field 503, respectively. Further, a sub-record 511 is created, and information is recorded in a node field 504, and recording of “in processing” is performed in a status field 505 of the nodes involved in the Web service case. Incidentally, “in processing” corresponds to the state indicated by the symbol 213 in FIG. 2.

Next, at step 304, the status management service 100 is brought to the state where a notification from each processing node is waited for, and at step 305, the status management service 100 receives the notification 306 from a certain processing node. The notification 306 corresponds to notifications 409, 411, and 416 in FIG. 4, which will be described hereinafter.

Next, at step 307, the status management service 100 checks the content of the notification. When the notification 306 has been determined to be the notification of completion of node processing, the status management service 100 updates the case DB at step 308. For updating the case DB, the status management service 100 extracts the record corresponding to the information in the case ID field 501 and the node field 504 in FIG. 5, which will be described hereinafter, according to the case ID and the name of the node included in the notification 306, and changes the information in the status field 505 of the node from “in processing” to “waiting for completion”. “Waiting for completion” corresponds to the state indicated by the symbol 212 in FIG. 2.

Next, at step 309, the status management service 100 extracts the case corresponding to the information in the case ID field 501 in FIG. 5, which will be described hereinafter, according to the case ID included in the notification 306. Then, the status management service 100 checks the status field 505 of the nodes involved in the case. If a node for which “in processing” is recorded is still present, the operation is returned to step 304. If recording of “waiting for completion” is performed on all the nodes, the operation proceeds to step 310. Then, at step 310, the status management service 100 transmits a case completion notification 311 to each of the nodes involved in the case, thereby completing the processing related to the case. The case completion notification 311 corresponds to a notification 419 in FIG. 4, which will be described hereinafter, and by which the operation proceeds from step 420 to step 421.

On the other hand, when the content of the notification has been determined to be a cancellation request at step 307, the status management service 100 extracts the case corresponding to the information in the case ID field 501 in FIG. 5, which will be described hereinafter, according to the case ID included in the notification 306, and then transmits a cancellation notification 313 to the nodes involved in the case at step 312, thereby completing the processing related to the case. The cancellation notification 313 corresponds to the notification 419 in FIG. 4, which will be described hereinafter, and by which the operation proceeds from step 420 to 422.

Next, when the deadline for execution of the case recorded in the deadline field 502 has been reached while notification from each processing node is waited for at step 304, the operation proceeds to step 312, and the status management service 100 transmits the cancellation notification. When the content of the notification has been determined to the information of a transmission destination at step 307, the status management service 100 extracts the case corresponding to the information in the case ID field 501 in FIG. 5, which will be described hereinafter, according to the case ID included in the notification 306. Then, a record such as a sub-record 512, or a sub-record 513 is added, and the node of the transmission destination included in the notification 306 is recorded in the node field 504. Then, “in processing” is recorded in the status field 505 of the node at step 314. “In processing” corresponds to the state indicated by the symbol 213 in FIG. 2.

Digital signature or encryption may be performed on the notifications 302, 306, 311, 313 in order to avoid a security risk such as falsification or spoofing.

FIG. 4 shows a processing flow of each of the processing nodes 120 and 130. When the processing node is a start node like the node 201 in FIG. 2, the processing node first receives a message 402 requesting execution of a Web service case from the client 110 at step 401.

Next, at step 403, the processing node transmits the case registration information 404 at the start of the Web service case to the status management service 100, and the operation proceeds to step 405. The case registration information 404 corresponds to the case registration information 302 in FIG. 3.

When the processing node is an intermediate node or an end node like the nodes 202 and 203 in FIG. 2, the processing node first receives the message 414 requesting execution of a sub Web service from the preceding node. Then, the operation proceeds to step 405. The message 414 corresponds to each of the arrows 211 in FIG. 2.

At step 405, the processing node performs arbitrary processing specific to the node. This processing corresponds to the processing performed by the node-specific processing unit 121 or 131 in FIG. 1. This processing is executed by the function of the program or the object set in the node in advance. By analyzing an input message, which processing is to be performed is determined.

Next, at step 407, the processing node determines whether the processing specific to the node in step 405 was properly performed or an error occurred in the processing. When it has been determined that the error occurred in the processing, the processing node transmits the cancellation request 409 to the status management service 100 at step 408, thereby completing the processing by the node related to the case.

On the other hand, when the processing node has determined at step 407 that the processing was properly performed, the processing node determines at step 410 whether a subsequent node is present for the processing of the Web service case. When the subsequent node is present, the operation proceeds to step 411. When the subsequent node is not present, the operation proceeds to step 415.

At step 411, the processing node transmits the transmission destination information 412 to the status management service 100. The transmission destination information 412 corresponds to the notification 306 in FIG. 3, and by the notification 306, the operation proceeds from step 307 to step 314. Further, at step 413, the processing node transmits the message 414 requesting execution of a sub Web service to the subsequent node. Incidentally, for execution of the sub Web service, a plurality of subsequent nodes may be present, and in this case, the processing node sequentially transmits the message 414 to the subsequent nodes.

Next, at step 415, the processing node transmits the notification 416 indicating completion of the processing by the node to the status management service 100. The notification 416 indicating completion of the processing corresponds to the notification 306 in FIG. 3, by which the operation proceeds from step 307 to step 308.

Next, at step 417, the processing node is brought to the state where a notification from the status management service 100 is waited for. Then, at step 418, the processing node receives the notification 419. The notification 419 corresponds to the notifications 311 and 313 in FIG. 3.

Next, at step 420, the content of the notification 419 is checked. Then, when the notification 419 has been determined to be the notification of completion, arbitrary processing for completion specific to the processing node such as a database commit is performed at step 421, thereby completing the processing by the node related to the case.

On the other hand, when the content of the notification has been determined to the cancellation notification at step 420, arbitrary processing for cancellation specific to the processing node such as a database rollback is performed at step 422, thereby completing the processing by the node related to the case.

Digital signature or encryption may be performed on the notifications 402, 404, 409, 412, 414, 416, and 419 so as to avoid the security risk such as falsification and spoofing.

FIG. 5 shows an example of a case status table. The case status table is stored in the case DB 102.

Referring to FIG. 5, the case status table 500 includes the case ID field 501 for describing a case ID for uniquely identifying a case, the deadline field 502 for describing a deadline for processing of the case, the start node field 503 for describing a start node for the case, a node field 504 for describing a list of nodes related to the case, and a status field 505 for describing processing statuses of the respective nodes related to the case. In the case status table 500, information in each of the record 510 and a record 520 corresponds to information on a single case. The records 510 and 520 are created in step 303 in FIG. 3.

Information in the sub-records 511, 512, and 513 and a sub-record 514 within the record 510 correspond to information on the nodes related to the case in the record 510, and are created at step 314 in FIG. 3. The statuses of these sub-records are updated at step 308.

The record 510, for example, indicates the state shown in FIG. 2. The sub-record 511 corresponds to the start node 201 and indicates that the node is in the state of “waiting for completion”, indicated by the symbol 212. The sub-record 512 corresponds to the end node 202, and indicates that the node is in the state of “in processing”, indicated by the symbol 213. The sub-record 513 corresponds to the intermediate node 203 and indicates that the node is in the state of “waiting for completion”, indicated by the symbol 212. The sub-record 514 corresponds to the intermediate node 204 and indicates that the node is in the state of “in processing”, indicated by the symbol 213.

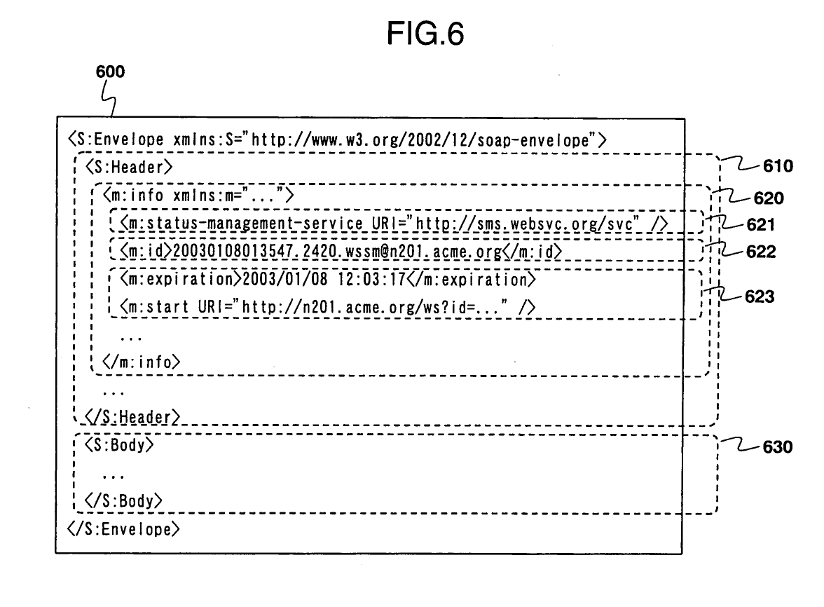

FIG. 6 shows an example of a message transmitted and received between the processing nodes and corresponds to the messages presented by the arrows 211 in FIG. 2 and 414 in FIG. 4.

Referring to FIG. 6, a message 600 is constituted from a message header 610 and a message body 630. The message header 610 has an element 620 that includes information for controlling a series of messages related to a Web service case. The element 620 includes the status management service location information 621 used for the Web service case and a case ID 622 for uniquely identifying the Web service case. The case ID 622 corresponds to the case ID recorded in the case ID field 501 in FIG. 5. In addition to the status management service location information 621 and the case ID 622, the element 620 may include information of the deadline and the start node like the information indicated by element 623. The message 600 may further include other information specific to the Web service and sub Web services related to the Web service within the message header 610 and the message body 630. By setting positional information of the start node in the status management service location information 621, execution of the status management service by the start node becomes possible.

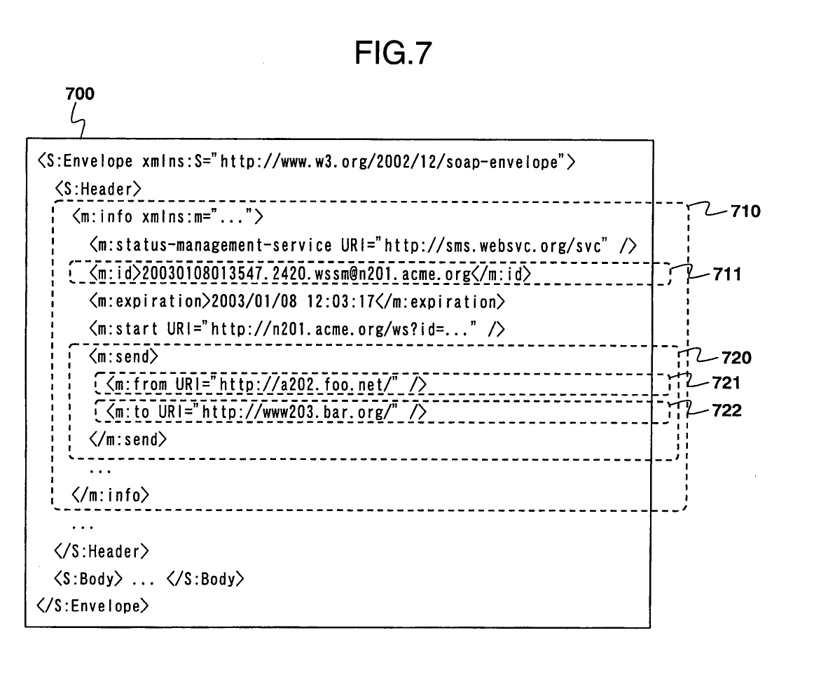

FIG. 7 shows an example of a notification indicating information of a transmission destination transmitted from a processing node to the status management service 100. The transmission destination indicates the node subsequent to the processing node. This notification corresponds to the notification 412 in FIG. 4. Referring to FIG. 7, a notification 700 has an element 710 that includes information for controlling a series of messages related to a Web service. The element 710 includes at least a case ID 711 for uniquely identifying the Web service case and transmission destination information 720. The transmission destination information 720 further includes a message transmission source 721 and a message transmission destination 722.

The status management service 100 that has received the notification 700 updates the case DB 102 according to the content of the transmission destination information 720 at step 314 in FIG. 3.

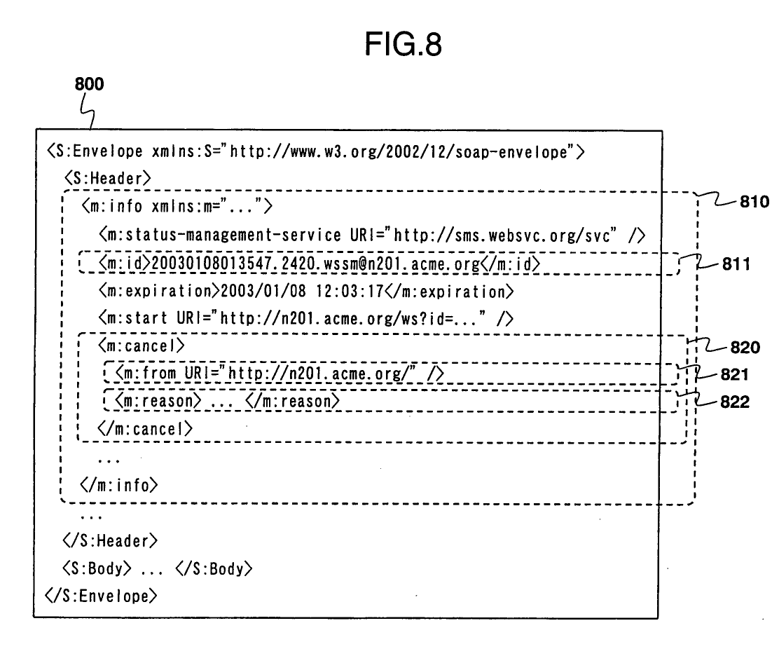

FIG. 8 shows an example of a cancellation notification, transmitted and received between a processing node and the status management service 100, and corresponds to the notification 313 in FIG. 3 or the notification 409 in FIG. 4.

Referring to FIG. 8, a notification 800 has an element 810 that includes information for controlling a series of messages related to a Web service case. The element 810 includes at least a case ID 811 for uniquely identifying the Web service case, and cancellation information 820. Further, the cancellation information 820 may include at least information 821 of a node that has requested cancellation and a cancellation reason 822.

The status management service 100 that has received the notification 800 transmits the cancellation notification 313 to respective nodes related to the Web service case, registered in the case DB 102, at step 312 in FIG. 3.

2. Second Embodiment

Another embodiment of the present invention will be described below.

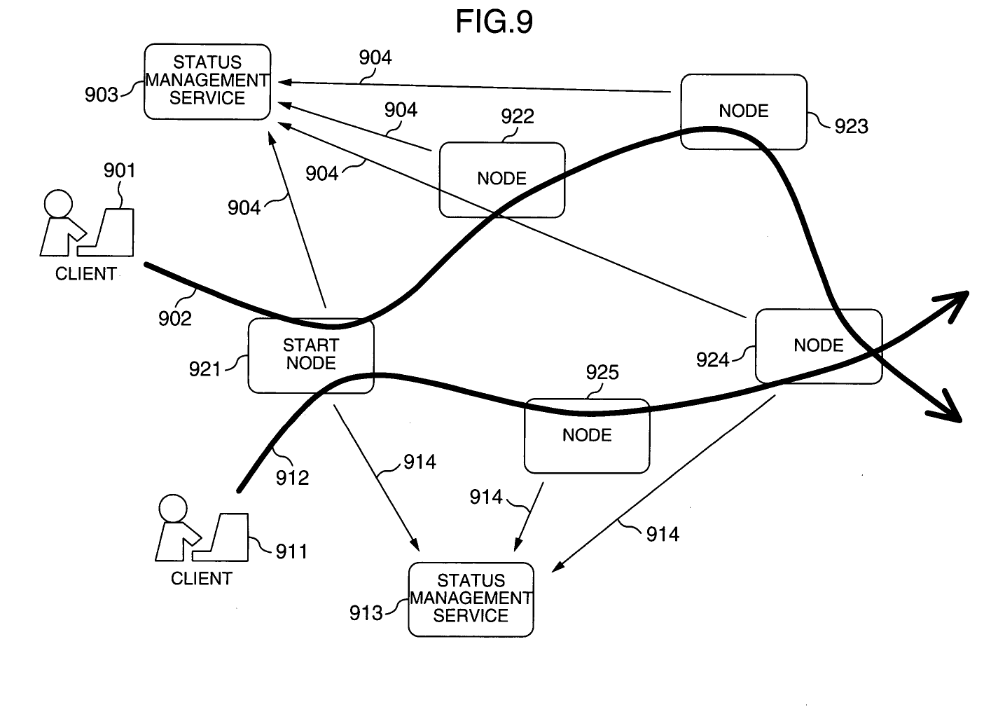

FIG. 9 illustrates an example showing a plurality of flows of service processing messages and notifications of transmission destination information when a plurality of status management services is present on a network. Referring to FIG. 9, flows 902 and 912 of the service processing messages are occurred which have passed through a plurality of processing nodes according to messages requesting service processing transmitted from clients 901 and 911.

The service processing message flow 902 passes through a start node 921 and nodes 922, 923, and 924, and the notifications of transmission destination information 904 are transmitted to a status management service 903 in accordance with information for identifying the status management service described in the service processing messages included in the flow 902 during the processes of these nodes. Each of the notifications of transmission destination information 904 corresponds to the notification 412 in FIG. 4. The status conditions of the case related to the service processing message flow 902 are recorded in the status management service 903. Then, the processing shown in the embodiment described before can be performed on the case.

Likewise, the service processing message flow 912 passes through the start node 921, nodes 925 and 924, and notifications of transmission destination information 914 are transmitted to a status management service 913 in accordance with information for identifying the status management service described in the service processing messages included in the flow 912 during the processes of these nodes. Each of the notifications of transmission destination information 914 corresponds to the notification 412 in FIG. 4. The status conditions of the case related to the service processing message flow 912 are recorded in the status management service 913. Then, the processing shown in the embodiment described before can be performed on the case.

Though the service processing message flows 902 and 912 have the common start node 921, the flows may have different start nodes. The clients 901 and 911 may serve as the start nodes. The start nodes may serve the status management services 903 and 913. Further, the client may select the status management services related to a case, or the start node may select the status management services related to the case.

It should be further understood by those skilled in the art that although the foregoing description has been made on embodiments of the invention, the invention is not limited thereto and various changes and modifications may be made without departing from the spirit of the invention and the scope of the appended claims.

1. A service processing method in a service processing system including a first node for performing processing in accordance with the received message, a second node for performing processing in accordance with the message received from the first node, a third node for performing processing in accordance with the message received from the second node, and a management node, the method comprising the steps of:
in the first node, processing a predetermined service based on a received processing request upon reception of the message including transmission source identification information, identification information on a case, and the processing request, transmitting a message including the received transmission source identification information and the received case identification information to the management node, and transmitting a message including the transmission source information and completion information indicating an error in processing of the predetermined service to the management node when the error occurs;
in the second node, processing a predetermined service in accordance with a received processing request upon reception of the message including the transmission source identification information, the case identification information, and a processing request, transmitting a message including the received transmission source identification information and the received case identification information to the management node, and transmitting a message including the transmission source information and the completion information indicating an error in processing of the predetermined service to the management node when the error occurs; and
in the management node, storing the transmission source identification information in a case database when the message received therein includes the transmission source information and the case identification information, and transmitting a message including cancellation information to the nodes corresponding to the stored transmission source information in accordance with the stored transmission source information when the received message includes the case identification information and the completion information indicating the error.

2. The service processing method according to claim 1, wherein the management node is the first node.

3. A service processing method in a service processing system including a first node for performing processing in accordance with a received message, a second node for performing processing in accordance with the message received from the first node, a third node for performing processing in accordance with the message received from the second node, and a management node, the method comprising the steps of:
in the first node, transmitting to the management node a message including transmission source identification information and identification information on a case, upon reception of the message including the transmission source identification information, the case identification information, and a processing request, transmitting to the second node the message including the transmission source identification information, the case identification information, transmission destination identification information, and a processing request, and transmitting to the management node a message including the case identification information, the transmission source information, and completion information indicating normal completion after processing of a predetermined service based on the received processing request is completed normally;
in the second node, transmitting to the management node a message including the transmission source identification information and the case identification information, upon reception of the message including the transmission source identification information, the case identification information, and a processing request, transmitting to the management node a message including the transmission source identification information, the case identification information, and completion information indicating normal completion after processing of a predetermined service in accordance with the received processing request is completed normally; and
in the management node, storing the case identification information, the transmission source identification information, and status information indicating that processing is being performed when the received message includes the transmission source identification information and the case identification information, changing and storing the status information corresponding to the case identification information and the transmission source identification information to status information indicating that completion of the case is waited for, when the received message includes the transmission source identification information, the transmission destination identification information, and the case identification information, and deleting the transmission source identification information corresponding to the case identification information and the status information corresponding to the transmission source identification information when the received message includes the transmission source information and the completion information indicating the normal completion.

4. The service processing method according to claim 3, wherein the first node processes the predetermined service in accordance with the received processing request upon reception of the message including the transmission source identification information, the case identification information, and the processing request, transmits to the management node the message including the transmission source identification information and the case identification information, and transmits to the management node a message including the transmission source identification information and completion information indicating an error in processing of the predetermined service when the error occurs;
the second node processes the predetermined service in accordance with the received processing request upon reception of the message including the transmission source identification information, the case identification information, and the processing request, transmits to the management node the message including the received transmission source identification information and the received case identification information, and transmits to the management node a message including the transmission source identification information and completion information indicating an error in processing of the predetermined service when the error occurs; and
the management node stores the transmission source identification information in a case database when the received message includes the transmission source identification information and the case identification information, and transmits to the nodes corresponding to the stored transmission source information a message including cancellation information in accordance with the stored transmission source identification information when the received message includes the case identification information and the completion information indicating the error.

5. The service processing method according to claim 3, wherein the management node is the first node.

6. A service processing method comprising a plurality of nodes and a management node, wherein each of the nodes analyzes a message in response to input of the message, transmits to the management node information on a case and identification information on said each of the nodes, included in the message, and transmits to the management node a request for cancellation of the case when an error occurs in processing of a predetermined service by said each of the nodes; and
the management node stores the case information and the identification information on said each of the nodes in association with each other, in response to input of the case information and the identification information on said each of the nodes, analyzes the request for the cancellation in response to input of the request for the cancellation, and notifies the cancellation and the case information for which the cancellation has occurred to the nodes corresponding to the case information.

7. The service processing method according to claim 6, wherein the management node is a start node.

8. A service processing system comprising a plurality of nodes and a management node, wherein each of the nodes comprises:
means for analyzing a message in response to input of the message, transmitting to the management node information on a case and identification information on said each of the nodes, included in the message, and transmitting to the management node a request for cancellation of the case when an error occurs in processing of a predetermined service by said each of the nodes; and
the management node comprises:
means for storing the case information and the identification information on said each of the nodes in association with each other, in response to input of the case information and the identification information on said each of the nodes, analyzing the request for the cancellation in response to input of the request for the cancellation, and notifying the cancellation and the case information for which the cancellation has occurred to the nodes corresponding to the case information.

9. A service processing program for a service processing system including a plurality of nodes and a management node, comprising:
a module, executed in each of the nodes, for analyzing a message in response to input of the message, transmitting to the management node information on a case and identification information on said each of the nodes, included in the message, and transmitting to the management node a request for cancellation of the case when an error occurs in processing of a predetermined service by said each of the nodes; and
a module, executed in the management node, for storing the case information and the identification information on said each of the nodes in association with each other, in response to input of the case information and the identification information on said each of the nodes, analyzing the request for the cancellation in response to input of the request for the cancellation, and notifying the cancellation and the case information for which the cancellation has occurred to the nodes corresponding to the case information.

10. A service processing method using a plurality of nodes and a management node, wherein the management node stores information on a case and identification information on each of the nodes in association with each other, in response to input of the case information and the identification information on said each of the nodes, analyzes a request for cancellation of the case in response to input of the request for the cancellation, and notifies the cancellation and the case information for which the cancellation has occurred to the nodes corresponding to the case information.
